(19) United States
(12) Patent Application Publication
(10) Pub. No.: US 2005/0053816 A1
(43) Pub. Date: Mar. 10, 2005

(54) Burner for combusting the anode exhaust gas stream in a PEM fuel cell power plant

(76) Inventors: Anuj Bhargava, South Windsor, CT (US); Brian A. Knight, Tolland, CT (US); Willard H. Sutton, Glastonbury, CT (US); Martin F. Zabielski, Manchester, CT (US)

Correspondence Address: William W. Jones, 6 Juniper Lane, Madison, CT, 06443, US

(21) Appl. No.: 10/294,344

(22) Filed: Nov. 15, 2002

(51) Int. Cl. H01M 8/04

(52) U.S. Cl. 429/26; 429/13

(57) ABSTRACT

A catalyzed burner is operative to combust an anode exhaust stream from a polymer electrolyte membrane (PEM) fuel cell power plant. The catalysts coated onto the burner can be platinum, rhodium, palladium, or mixtures thereof. The burner includes open cells which are formed by a lattice, which cells communicate with each other throughout the entire catalyzed burner. The burner is able to combust hydrogen in the anode exhaust stream. The catalyzed burner has a high surface area wherein about 70-90% of the volume of the burner is preferably open pores, and the burner has a low pressure drop of about two to three inches water from the anode exhaust stream inlet to the anode exhaust stream outlet. The burner assembly operates at essentially ambient pressure and at a temperature of up to about 1,700° F. (927° C.). The burner can combust anode exhaust during normal operation of the fuel cell assembly. The burner is not adversely affected by gasoline, gasoline combustion products, or anode bypass gas, the latter of which is a reformed fuel gas which is tapped off of the fuel cell stack fuel inlet line.

### TECHNICAL FIELD

This invention relates to a catalyzed burner which can combust the anode exhaust stream from a polymer electrolyte membrane (PEM) fuel cell to produce heat for use in a PEM fuel cell power plant.

### BACKGROUND ART

Polymer electrolyte membrane (PEM) fuel cells operate at relatively low temperatures, typically in the range of about 100° F. (38° C.) to about 200° F. (93.3° C.), and often at essentially ambient pressure. A PEM cell anode exhaust gas stream primarily contains water, carbon dioxide and small amounts of hydrogen. For efficiency and emission reasons, the fuel remaining in the anode exhaust gas stream after it passes through the fuel cell power plant cells should be used in the operation of the PEM cell power plant. However, this cannot be done with a conventional metal burner. The inability to utilize the anode exhaust gas stream from a PEM fuel cell power plant to provide additional energy for operation results from: a) the high water and CO₂ content in the anode exhaust stream; and b) the low hydrogen content of the anode exhaust stream. In addition, the high turn down ratio of flows required exceeds conventional burner capabilities.

It would be desirable to be able to utlize an anode exhaust gas stream in a PEM fuel cell power plant to provide energy for operating the power plant in order to improve system efficiency, and to provide reduced power plant emissions levels.

### DESCRIPTION OF THE INVENTION

This invention relates to a burner which is operative to combust the anode exhaust stream of a PEM fuel cell power plant to provide energy for operation of the power plant.

A PEM fuel cell power plant is a low temperature power plant, and operates at a temperature in the range of about 100° F. (38° C.) to about 200° F. (93.3° C.), and preferably at about 180° F. (82.2° C.), and preferably at essentially ambient pressures. For PEM fuel cells using any form of steam reformer, steam production from the cell stack waste heat is not an option, as it is with 400° F. (204° C.) phosphoric add cells, so alternative steam production methods are required. As a result, the anode exhaust energy is the prime source for heat to create steam, but the anode exhaust consists largely of a small amount of H₂, with CO₂, water vapor and, in the case of autothermal reformer, catalytic partial oxidation reformer, or partial oxidation reformer units, some N₂. The hydrogen in the anode exhaust stream is typically below the normal combustibility level, thus we employ a catalyzed porous burner to burn the anode exhaust gas stream.

The burner of this invention enables combustion of the PEM cell anode exhaust gas stream thus producing heat that can be used for producing steam for a reformer in the fuel cell power plant, or for other purposes in operating the power plant, or in its environs. The burner of this invention is impervious to damage from exposure to gasoline or gasoline combustion products which may be utilized during start up of the power plant. The burner of this invention includes a catalyzed porous ceramic open cell foam burner member. The catalyst which is coated on the burner can be platinum, rhodium, or palladium, and combinations thereof. The burner body is preferably an open cell metallic or ceramic foam which provides an open cell porosity that is in the range of about 70% to about 90%. With this degree of porosity, the majority of combustion of the gas stream takes place internally of the burner body, and the pressure drop from the inlet to the outlet of the burner body can be as low as about two to about three inches water at operating conditions. This degree of porosity also allows the burner operating pressures to be at essentially ambient pressure. The operating temperature of the burner can be as high as about 1,700° F. (927° C.), but is preferably less than 1,195° F. (646° C.).

The burner of this invention is particularly useful in mobile environs which utilize a PEM power plant to produce electricity on demand, which demand may vary. One such mobile environ is an automobile, bus, or other vehicles. Operating vehicles with electricity provided by PEM fuel cells wherein the anode exhaust gas stream produced by the cell stack is burned to provide heat for the system, requires that the burner have a relatively high turn down ratio. The phrase “turn down ratio” refers to the ratio of the maximum fuel and air flow rate to the minimum fuel and air flow rate. The burner of this invention has a 10:1 turn down ratio as compared to a conventional burner turn down ratio of 3:1, and the 10:1 turn down ratio cannot be met by conventional burners because of blow-off, flashback or extinction problems that conventional burners encounter. In addition, in automotive applications which operate at or near ambient pressures, overall system efficiency requires that the system inlet to outlet pressure drop including the burner be kept at a minimum.

It is therefore an object of this invention to provide a catalytic burner which is operative to combust the exhaust gas stream from the anode side of a PEM fuel cell power plant.

It is a further object of this invention to provide a burner of the character described that is not adversely affected by gasoline combustion products or PEM fuel cell power plant anode bypass gas during start-up of the power plant.

It is another object of this invention to provide a burner of the character described which has a high open cell porosity thus providing a very large catalyzed surface area per unit volume of the burner.

It is still a further object of this invention to provide a burner of the character described which can be operated at essentially ambient pressures and has a low burner inlet to burner outlet pressure drop.

These and other objects of the invention will become more readily apparent from the following detailed description of embodiments of the invention when considered in conjunction with the accompanying drawings, in which:

### BRIEF DESCRIPTION OF THE DRAWINGS

FIG. 1 is a schematic view of a solid polymer electrolyte membrane fuel cell power plant assembly which includes an anode exhaust gas stream combustion station which is formed in accordance with this invention;

FIG. 2 is a schematic view of one embodiment of a burner/steam generating station for use in the power plant assembly of this invention; and

FIG. 3 is a schematic sectional view of the catalyzed burner of this invention.

### DETAILED DESCRIPTION OF THE INVENTION

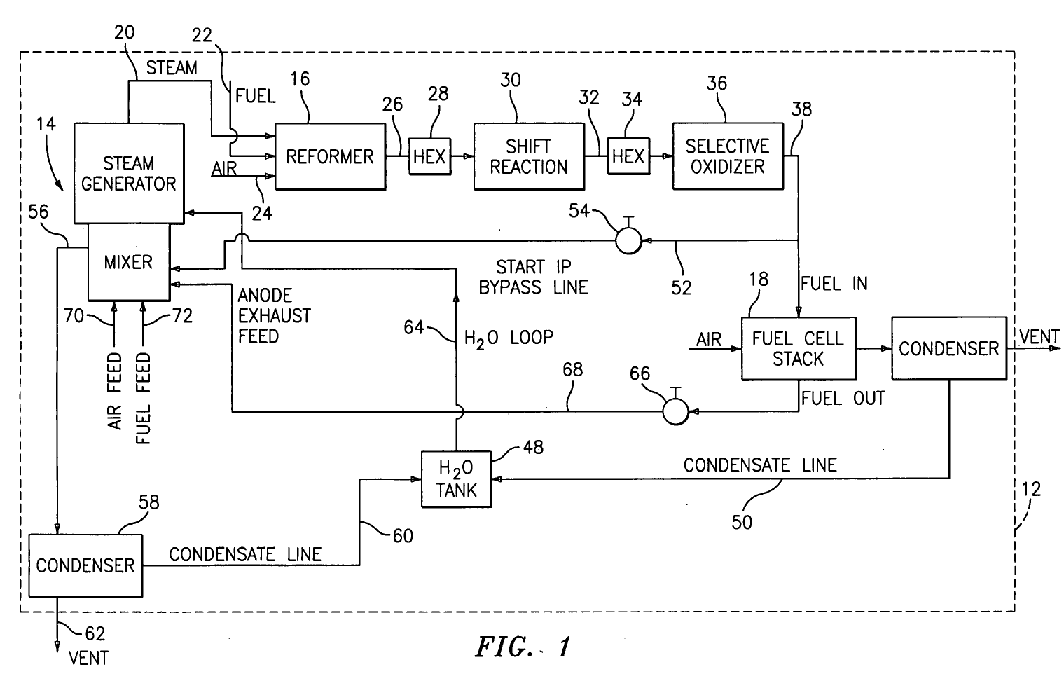

Referring now to the drawings, there is shown in FIG. 1 a schematic view of a solid polymer electrolyte membrane (PEM) fuel cell power plant, denoted generally by the numeral 12, which is formed in accordance with this invention. The power plant 12 includes a multi-fuel burner/steam generating station 14 which produces steam for a reformer 16 as well as provide heat to raise the temperature of power plant components during start up. The reformer 16 converts a hydrocarbon fuel such as gasoline, diesel, ethanol, methanol, natural gas, or the like, to a hydrogen-enriched gas stream which is suitable for use in the active fuel cell stack 18 in the power plant 12. The steam generator station 14 produces steam, which is fed to the reformer 16 via a line 20. The fuel to be reformed is fed to the reformer 16 via a line 22, and air, in the case of an autothermal reformer, is fed to the reformer 16 via a line 24. The reformed fuel gas stream exits the reformer via line 26 and passes through a heat exchanger 28 which cools the reformed fuel gas stream. The reformed fuel gas stream then flows through a shift reaction station 30 wherein much of the CO in the fuel gas stream is converted to CO₂. The fuel gas stream exits the station 30 via a line 32 and passes through a heat exchanger 34 wherein the fuel gas stream is cooled. The fuel gas stream then passes through a selective oxidizer 36 wherein the remaining CO in the fuel gas stream is further reduced and thence through a line 38 to the power plant fuel cell stack 18. The reformed fuel passes through the anode side of the fuel cells in the stack 18.

During startup the fuel gas stream bypasses the stack by being bled off from the line 38 through a line 52 which connects to the burner/mixer steam generator station 14 in order to provide additional fuel for heat up and to minimize emissions. A valve 54 serves to control the flow of fuel through the line 52, the valve 54 being actuated by a fuel cell power plant operating processor controller (not shown). Burner exhaust from the station 14 is removed from the station 14 via line 56 that directs the exhaust stream to a condenser 58 where water is condensed out of the exhaust stream. The water condensate is transferred from the condenser 58 to the water tank 48 through a line 60, and the dehydrated exhaust stream is vented from the power plant 2 through a vent 62. Water from the water storage tank 48 is fed to the steam generator station 14 through a line 64.

Once the fuel cell power plant 12 achieves operating temperature, the valve 54 will be closed and the valve 66 in a line 68 will be opened by the power plant controller. The line 68 directs the fuel cell stack anode exhaust stream to the station 14 wherein any residual hydrogen and hydrocarbons in the anode exhaust stream are combusted. The anode exhaust stream contains hydrogen, water and hydrocarbons. During startup of the power plant 12, the station 14 can be provided with air through line 70 and raw fuel for combustion through line 72 as well as anode bypass gas provided through line 52. The fuel can be natural gas, gasoline, ethanol, methanol, hydrogen or some other combustible material. Air is always provided to the station 14 through line 70 irregardless of the source of the combustible fuel.

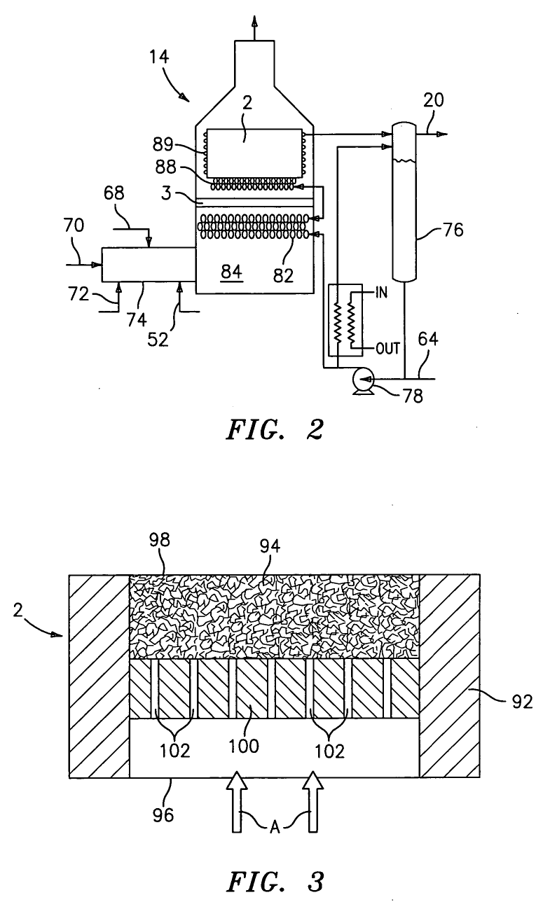

Referring now to FIG. 2, there is shown details of one embodiment of the burner/mixer steam generator station 14 of the power plant 12. The station 14 includes a first mixer/burner chamber 74 where the fuel (other than lean fuel anode exhaust) and air are combusted in a swirl-stabilized combustion burner during start up to produce steam. The hot exhaust of this gasoline burner passes through a first heat exchanger 82 which reduces the temperature of the gasoline burner exhaust to an acceptable level for the catalytic burner 2. The catalytic burner 2 is heated by the gasoline burner exhaust stream, and it is also used to reduce the carbon monoxide emissions from the gasoline burner. A gas stream diffuser 3 can be used to provide a diffuse flow of gasoline burner exhaust or anode exhaust to the catalytic burner 2.

Referring now to FIG. 3, there are shown details of the catalyzed burner 2. The burner 2 includes a tubular holder 92 inside of which an open cell foam ceramic body 94 is disposed. It should be noted that the body can also be metallic. The burner 2 can also take the form of a honeycomb. The interstices of the body 94 are catalyzed, i.e., are coated with a suitable catalyst, such as rhodium, platinum, palladium, and mixtures thereof. The air and fuel mixture flows into the burner 2 in the direction of the arrows A. Thus, the end 96 of the burner 2 is the “inlet” end, and the end 98 of the burner 2 is the outlet end. The burner 2 also includes a perforated ceramic air-fuel distribution plate 100 which has a plurality of through passages 102. The distribution plate 100 will evenly distribute fuel and air flowing into the catalyzed ceramic body 94 and will also prevent flashback during operation of the assembly. The plate 100 could also take the form of an open cell foam which has a pore size that is smaller than the pore size of the burner 2. Flashback occurs when the velocity of the flame moving back into the air-fuel supply is greater that the flow velocity of the air-fuel supply.

The gasoline start up burner has two purposes. During start up, prior to operation of the catalytic burner, it is used to produce hot gas for steam generation. It does this by mixing finely atomized gasoline droplets with air, and burning the gasoline. Gasoline is introduced into the burner by means of a pressure atomizing fuel injector and mixed with the air which enters through a swirler and a series of primary and secondary dilution holes. Proper sizing and placement of the air entry holes produces a stable recirculation zone in the vicinity of the fuel injector which ensures stable combustion without the need to actuate an igniter once ignition has taken place. This also produces complete combustion of the fuel and a relatively even exit temperature profile.

The other purpose of the gasoline burner is as an air/anode exhaust mixer which premixes air and anode exhaust gas prior to combustion on the catalytic burner. The start burner functions in this mixer mode during normal power plant operation when the remaining hydrogen in the anode exhaust is burned on the catalytic burner to produce the steam needed for power plant operation.

During startup of the fuel processing system, the hot gas from the gasoline burner 74 is used to transfer heat into water which is pumped by a circulating pump 78 through the first heat exchanger 82 and thence through a second heat exchanger 88 and a third heat exchanger 89. The circulating pump flow rate is sufficiently high to maintain two-phase flow in the heat exchangers 82, 88 and 89 at all times. The two phase (liquid/gas) component flow which is maintained, simplifies control requirements and limits heat exchanger size. This two-phase flow stream is pumped into a steam accumulator 76, where the liquid water is recirculated back through the heat exchangers 82, 88 and 89, while saturated steam is extracted from the accumulator 76 for use in the fuel processing system. Feed water to the circulating pump 78 is provided to maintain the liquid level in the accumulator at appropriate levels. As the fuel processing system begins to generate low-quality reformate, this reformate bypasses the anode of the fuel cell and is fed into the mixing section of the gasoline burner 74 to be combusted.

During normal operation, the fuel cell anode exhaust is supplied to the burner/mixer 74 together with air. The burner/mixer 74 functions as an air/anode exhaust mixer. After mixing of the fuel cell anode exhaust with air, the resultant mixture is fed into the catalytic burner 2, without reducing its ability to operate as a gasoline burner during the start up phase. The anode exhaust mixture is combusted catalytically in the catalytic burner 2. Radiant and convective heat from the catalytic burner 2 is transferred to the heat exchanger coils 88, with the remainder of the convective heat transfer occurring in the heat exchanger 89. As during startup operation, the circulating pump 78 maintains two-phase flow in the heat exchangers and saturated steam is extracted from the accumulator 76.

It will be readily appreciated that the burner of this invention will enable the use of anode exhaust to be used as a source of heat for producing steam for operating a PEM fuel cell power plant due to the inclusion of a catalytic burner in the assembly. The inclusion of an auxiliary gasoline or other conventional hydrocarbon fuel burner allows the catalyzed burner to bring the fuel cell power plant up to operating temperatures prior to the use of the anode exhaust stream as a source of energy to produce steam for the power plant. The inclusion of an air swirler in the auxiliary burner portion of the assembly enables adequate mixture of air with the anode exhaust stream prior to combustion in the catalytic burner part of the assembly.

Since many changes and variations of the disclosed embodiment of the invention may be made without departing from the inventive concept, it is not intended to limit the invention otherwise than as required by the appended claims.

1. A burner for use in a polymer electrolyte membrane (PEM) fuel cell power plant, said burner being operative to combust an anode exhaust gas emanating from a cell stack in the PEM fuel cell power plant, said burner comprising a porous catalyst-coated body.

2. The burner of claim 1 wherein said body is an open cell ceramic foam.

3. The burner of claim 1 wherein said body is an open cell metallic foam.

4. The burner of claim 1 further comprising a porous ceramic distribution plate which is operative to evenly distribute the anode exhaust gas into the burner.

5. The burner of claim 1 further comprising a porous metallic distribution plate which is operative to evenly distribute the anode exhaust gas into the burner.

6. The burner of claim 1 wherein said porous catalyst-coated body is coated with a catalyst selected from the group consisting of platinum, rhodium, palladium, and mixtures thereof.

7. The burner of claim 1 wherein said porous body has an open porosity which is in the range of about 70% to about 90% of the volume of the porous body.

8. The burner of claim 1 wherein the burner operates at essentially ambient pressure.

9. The burner of claim 1 wherein the burner has an inlet to outlet pressure drop of about 2 to about 3 inches water at operating conditions.

10. A method for combusting anode exhaust gas emanating from a cell stack in a PEM fuel cell power plant, said method comprising:
a) the step of providing a porous catalyst-coated body; and
b) the step of passing the anode exhaust gas through said body under conditions that will result in combustion of hydrocarbons in said anode exhaust gas.

11. The method of claim 10 wherein said body is an open cell ceramic foam.

12. The method of claim 10 wherein said body is an open cell metallic foam.

13. The method of claim 10 further comprising the step of providing a porous ceramic distribution plate which is operative to evenly distribute the anode exhaust gas into the burner.

14. The method of claim 10 further comprising the step of providing a porous metallic distribution plate which is operative to evenly distribute the anode exhaust gas into the burner.

15. The method of claim 10 wherein said porous catalyst-coated body is coated with a catalyst selected from the group consisting of platinum, rhodium, palladium, and mixtures thereof.

16. The method of claim 10 wherein said porous body has an open porosity which is in the range of about 70% to about 90% of the volume of the porous body.

17. The method of claim 10 wherein the burner operates at essentially ambient pressure.

18. The method of claim 10 wherein the burner has an inlet to outlet pressure drop of about 2 to about 3 inches water at operating conditions.
